(19) United States
(12) Patent Application Publication
(10) Pub. No.: US 2014/0204588 A1
(43) Pub. Date: Jul. 24, 2014

(54) LED LUMINOUS FLUX CONVERTING LENS AND LIGHTING APPARATUS INCLUDING THE SAME

(71) Applicants: INHA Industry Partnership Institute, Incheon (KR); Samsung Electronics Co., Ltd., Suwon-si (KR)

(72) Inventors: Sang-woo HA, Seongnam-si (KR); Seung-gol LEE, Incheon (KR); Jin-ha KIM, Yongin-si (KR)

(73) Assignees: INHA INDUSTRY PARTNERSHIP INSTITUTE, Incheon (KR); SAMSUNG ELECTRONICS CO., LTD., Suwon-si (KR)

(21) Appl. No.: 14/144,363

(22) Filed: Dec. 30, 2013

(30) Foreign Application Priority Data
Jan. 18, 2013 (KR) 10-2013-0006067

(51) Int. Cl. F21K 99/00

(52) U.S. Cl. CPC F21K 9/50
USPC 362/308; 362/327

(57) ABSTRACT

A light emitting device (LED) luminous flux converting lens including a bonding portion that bonds the LED luminous flux converting lens to a supporting plate to fix the LED luminous flux converting lens. The LED luminous flux converting lens includes a bonding portion that protrudes from a boundary of an upper surface in a horizontal direction, and the bonding portion includes a first portion and a second portion having different thicknesses. The LED luminous flux converting lens includes a bonding portion that protrudes from a portion of a boundary of the upper surface in a horizontal direction. A luminous flux efficiency of the LED luminous flux converting lens may be increased by reducing loss in a luminous flux due to the bonding portion.

### CROSS-REFERENCE TO RELATED APPLICATIONS

This application claims the benefit of priority to Korean Patent Application No. 10-2013-0006067, filed on Jan. 18, 2013, in the Korean Intellectual Property Office, the entire contents of which are hereby incorporated by reference.

### TECHNICAL FIELD

The present disclosure relates to LED luminous flux converting lenses and lighting apparatus including the same.

### BACKGROUND

The present disclosure relates to a luminous flux converting lens for a light emitting device (LED), and more particularly, to a luminous flux converting lens for LEDs, including a bonding portion that is bonded to a supporting plate included to fix the luminous flux converting lens for an LED.

An LED has excellent power consumption characteristics in comparison to light sources such as fluorescent lamps or an incandescent lamp and has a compact size, and thus is used in various applications. In particular, the LED has recently been used as a light source of a camera flash of a digital camera integrated in various mobile electronic appliances.

Meanwhile, unlike other light sources, a luminous flux emitted from an LED has directivity, and thus, in order for an LED to replace other light sources, the luminous flux of the LED needs to be converted. To convert a luminous flux emitted from an LED, generally, an LED luminous flux converting lens may be added on a surface of the LED. The LED luminous flux converting lens may be fixed at a predetermined position with respect to the LED. Also, in order to reduce a volume of the LED luminous flux converting lens and the LED, an LED luminous flux converting lens having a small thickness may be used.

Generally, a supporting plate is included to affix the LED luminous flux converting lens and the LED luminous flux converting lens typically includes a bonding portion that is bonded to the supporting plate. The bonding portion has to maintain a predetermined thickness so that the LED luminous flux converting lens is fixed to the predetermined position. The bonding portion decreases the efficiency of the lens by reducing light irradiated to the illumination surface, and this decrease in the efficiency of the lens is further intensified as the thickness of the bonding portion increases.

Accordingly, a need exists for reducing loss of luminous flux from a bonded LED luminous flux converting lens.

### SUMMARY

The present disclosure relates to a light emitting device (LED) luminous flux converting lens including a bonding portion that is bonded to a supporting plate included to fix the LED luminous flux converting lens, whereby luminous flux efficiency is improved.

An aspect of the present disclosure relates to a light emitting device (LED) luminous flux converting lens comprising: a lower surface that is separated from a substrate on which an LED is mounted, the lower surface facing the LED; an upper surface that is larger than the lower surface and is parallel to the lower surface; an outer side surface that extends from the lower surface to the upper surface; and a bonding portion that protrudes from a boundary of the upper surface and is bonded to a supporting plate that fixes the LED luminous flux converting lens, wherein the bonding portion comprises a plurality of first portions and a second portion that is thicker than the first portions in a vertical direction.

A horizontal cross-section of the upper surface, a horizontal cross-section of the lower surface, and a horizontal cross-section of the outer side surface may be rectangular.

The first portion may protrude from a pair of parallel sides of the upper surface, and the second portion may protrude from another pair of parallel sides of the upper surface.

The plurality of first portions may protrude from a portion of respective sides of the upper surface, and the second portion may be connected to each vertex of the upper surface and may be disposed between the adjacent first portions.

The rectangular horizontal cross-section of the upper surface, the rectangular horizontal cross-section of the lower surface, and the rectangular horizontal cross-section of the outer side surface may each have an aspect ratio that is appropriate for an angle of view of a camera lens.

A recess may be dented in the lower surface, a refraction surface may have an aspherical lens structure and may be disposed on a bottom surface of the recess, and an inner side surface may extend from the refraction surface to the lower surface.

A vertical thickness of the second portion may be one of greater than or equal to 0.2 mm and equal to or less than a thickness of the LED luminous flux converting lens, and a vertical thickness of the first portion may be equal to or less than half of the vertical thickness of the second portion.

An aspect of the present disclosure relates to a light emitting device (LED) luminous flux converting lens comprising: a lower surface that is separated from a substrate on which an LED is mounted, the lower surface facing the LED; an upper surface that is larger than the lower surface and is parallel to the lower surface; an outer side surface that extends from the lower surface to the upper surface; and a bonding portion that protrudes from a portion of a boundary of the upper surface and is bonded to a supporting plate that fixes the LED luminous flux converting lens, wherein the outer side surface comprises a first area that connects the lower surface and the upper surface and a second area that connects the lower surface and the bonding portion.

A horizontal cross-section of the upper surface, a horizontal cross-section of the lower surface, and a horizontal cross-section of the outer side surface may be rectangular.

The bonding portion may protrude from a pair of parallel sides of the upper surface, and the first area may connect another pair of parallel sides of the upper surface and the lower surface.

The first area may connect a portion of each side of the upper surface and the lower surface, and the bonding portion may be connected to each vertex of the upper surface and may protrude from a portion of the boundary of the upper surface that is not connected to the first area.

The rectangular horizontal cross-section of the upper surface, the rectangular horizontal cross-section of the lower surface, and the rectangular horizontal cross-section of the outer side surface may each have an aspect ratio that is appropriate for an angle of view of a camera lens.

A recess may be is dented in the lower surface, a refraction surface may have an asphercial lens structure and may be disposed on a bottom surface of the recess, and an inner side surface may extend from the refraction surface to the lower surface.

A vertical thickness of the bonding portion may be one of greater than or equal to 0.2 mm and equal to or less than a thickness of the LED luminous flux converting lens.

The LED luminous flux converting lens may be formed of silicon.

An aspect of the present disclosure relates to a lighting apparatus. The lighting apparatus may include a substrate and an LED disposed on an upper surface of the substrate. The lighting apparatus may also include an LED luminous flux converting lens disposed over the LED, wherein the LED luminous flux converting lens includes a lower surface that is separated from the substrate on which the LED is disposed, the lower surface facing the LED, an upper surface that is larger than the lower surface, an outer side surface that extends from the lower surface to the upper surface, and a bonding portion that protrudes from a boundary of the upper surface and is bonded to a supporting plate that fixes the LED luminous flux converting lens, wherein the bonding portion includes a plurality of first portions and a second portion that is thicker than the first portions in a vertical direction.

A supporting plate may be disposed on the substrate, wherein the LED luminous flux converting lens may be disposed on the supporting plate and a portion of the LED luminous flux converting lens may be bonded to the supporting plate.

The bonding portion may protrude from a pair of parallel sides of the upper surface, and the first area may connect another pair of parallel sides of the upper surface and the lower surface.

The first area may connect a portion of each side of the upper surface and the lower surface, and the bonding portion may be connected to each vertex of the upper surface and protrude from a portion of the boundary of the upper surface that is not connected to the first area.

A recess may be dented in the lower surface, a refraction surface may have an asphercial lens structure and be disposed on a bottom surface of the recess, and an inner side surface may extend from the refraction surface to the lower surface.

### BRIEF DESCRIPTION OF THE DRAWINGS

The foregoing and other features of the present disclosure will be apparent from more particular description of embodiments of the inventive concept, as illustrated in the accompanying drawings in which like reference characters may refer to the same or similar elements throughout the different views. The drawings are not necessarily to scale, emphasis instead being placed upon illustrating the principles of the embodiments of the inventive concept. In the drawings, the thickness of layers and regions may be exaggerated for clarity.

Exemplary embodiments of the present disclosure will be more clearly understood from the following detailed description taken in conjunction with the accompanying drawings in which:

FIG. 1 is a perspective view illustrating a light emitting device (LED) luminous flux converting lens according to an embodiment of the present disclosure;

FIG. 2 is a cross-sectional front elevation view illustrating a module including an LED luminous flux converting lens according to an embodiment of the present disclosure;

FIGS. 3A and 3B are cross-sectional front elevation views illustrating an influence of the LED luminous flux converting lens on conversion of a luminous flux emitted from an LED, according to an embodiment of the present disclosure;

FIGS. 4A and 4B are graphs showing distribution of illuminance of light that transmits through an LED luminous flux converting lens according to whether a bonding portion is included or not;

FIG. 5 is a graph showing a variation in a luminous flux efficiency according to a thickness of a bonding portion;

FIGS. 6A through 6C are perspective and cross-sectional front elevation views illustrating an LED luminous flux converting lens according to an embodiment of the present disclosure;

FIGS. 7A through 7C are perspective and cross-sectional front elevation and side views illustrating an LED luminous flux converting lens according to an embodiment of the present disclosure;

FIGS. 8A through 8C are perspective and cross-sectional front elevation views illustrating an LED luminous flux converting lens according to an embodiment of the present disclosure; and

FIGS. 9A and 9B are perspective and top plan views illustrating an LED luminous flux converting lens according to an embodiment of the present disclosure.

### DETAILED DESCRIPTION OF THE EMBODIMENTS

Hereinafter, exemplary embodiments of the present disclosure will be described in more detail with reference to the accompanying drawings. The present disclosure may, however, be embodied in many different forms and should not be construed as being limited to the embodiments set forth herein. Rather, these embodiments are provided so that this disclosure will be thorough and complete, and will fully convey the scope of the inventive concept to those skilled in the art.

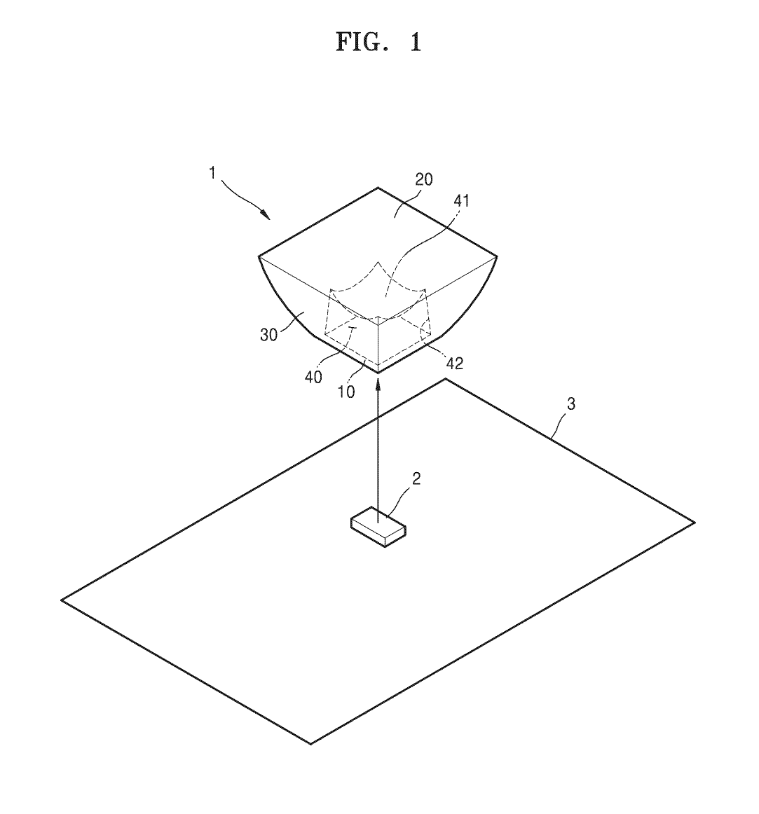

As illustrated in FIG. 1, a light emitting device (LED) luminous flux converting lens 1 has an LED 2 that may be mounted on a substrate 3, and may receive a current or the like from the substrate 3 to thereby emit light. The LED luminous flux converting lens 1 may be disposed on the substrate 3 on which the LED 2 is mounted. While FIG. 1 illustrates one LED 2 mounted on the substrate 3, a plurality of LEDs 2 may also be mounted on the substrate 3.

As illustrated in FIG. 1, the LED luminous flux converting lens 1 may include a lower surface 10, an upper surface 20, an outer side surface 30, and a recess 40. The lower surface 10 may be separated from the substrate 3, on which the LED 2 is mounted, thereby facing the LED 2. The upper surface 20 may have a larger area than the lower surface 10, and may be parallel to and above the lower surface 10. The upper surface 20 may be planar or curved.

The outer side surface 30 may extend from the lower surface 10 to the upper surface 20. According to an embodiment of the present disclosure, the outer side surface 30 may have a cross-section of a Bezier curve. A luminous flux emitted from the LED 2 of the substrate 3 may be incident into the LED luminous flux converting lens 1, and may be totally internally reflected by the outer side surface 30, thereby proceeding to the upper surface 20. This will be described in detail below.

According to an embodiment of the present disclosure, the recess 40 may be upwardly dented in the lower surface 10, and may have a larger size than the LED 2. A refraction surface 41 that refracts a luminous flux emitted from the LED 2 to proceed to the upper surface 20 may be formed on a bottom surface of the recess 40. For example, the refraction surface 41 may have a semi-spherical lens structure having a predetermined curvature radius, or may preferably be formed of an aspherical surface. Also, an inner side surface 42 of the recess 40 may extend from the refraction surface 41 to the lower surface 10. The inner side surface 42 may refract a luminous flux emitted from a lateral surface of the LED 2 so that it proceeds to the outer side surface 30.

Although FIG. 1 illustrates the lower surface 10, the upper surface 20, the outer side surface 30, and the recess 40 all having a rectangular horizontal cross-section, the embodiments of the present disclosure are not limited thereto. Horizontal cross-sections of the LED luminous flux converting lens 1 may also have a circular or oval shape. Also, the LED luminous flux converting lens 1 may be formed of a plastic or silicon.

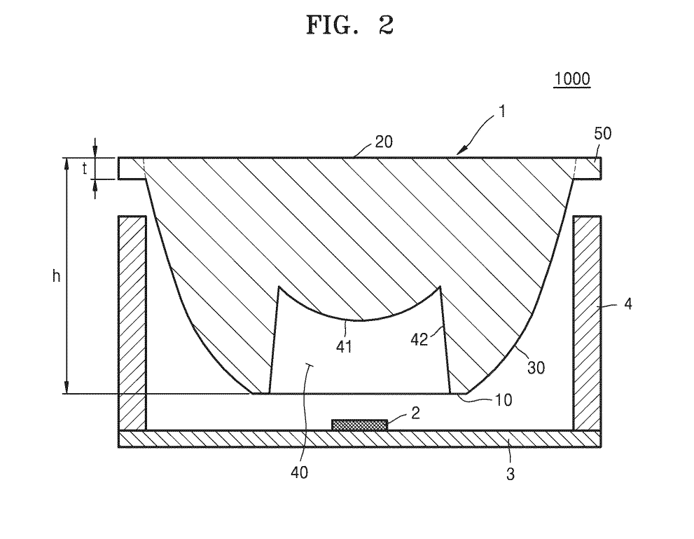

FIG. 2 illustrates a module 1000 including an LED luminous flux converting lens 1 according to an embodiment of the present disclosure. The module 1000 may include an LED luminous flux converting lens 1, an LED 2, a substrate 3, and a supporting plate 4. As described with reference to FIG. 1, the LED 2 may be mounted on the substrate 3, and may receive a current or the like from the substrate 3 to emit light. The LED luminous flux converting lens 1 may include a lower surface 10, an upper surface 20, an outer side surface 30, and a recess 40. The functions of the elements of the LED luminous flux converting lens 1 are described above with reference to FIG. 1, and thus descriptions thereof will be omitted.

Meanwhile, the module 1000 may include the supporting plate 4 to fix the LED luminous flux converting lens 1. The supporting plate 4 may be attached to the substrate 3 or a structure included in the module 1000, or may be formed as a portion of the structure.

According to an embodiment of the present disclosure, to fix a position of the LED luminous flux converting lens 1, the LED luminous flux converting lens 1 may include a bonding portion 50 that is to be bonded to the supporting plate 4 to fix the LED luminous flux converting lens 1. The LED luminous flux converting lens 1 may be disposed at a particular position with respect to the LED 2 in order to convert a luminous flux emitted from the LED 2. For example, the LED luminous flux converting lens 1 may be disposed such that a central point of each of the lower surface 10, the upper surface 20, and the refraction surface 41 and a central point of the LED 2 correspond to one other in a perpendicular direction.

The bonding portion 50 may have a sufficient thickness t such that the LED luminous flux converting lens 1 may be fixed via the supporting plate 4 while maintaining a predetermined mechanical intensity. For example, if the thickness t of the bonding portion 50 is not sufficient, and an external impact is applied to the LED luminous flux converting lens 1 from the outside of the module 1000, the bonding portion 50 may be separated from the LED luminous flux converting lens 1. Accordingly, the LED luminous flux converting lens 1 may be separated out of the module 1000 or may be shifted to an undesired position.

Meanwhile, according to application types for using module 1000, a module 1000 including an LED luminous flux converting lens 1 having a small thickness h may be used. For example, for a camera flash integrated in a mobile phone, the module 1000 having a small thickness may be used for achieving a lighter-weight of the mobile phone, and the LED luminous flux converting lens 1 may have a thickness h of 2 mm or less. The bonding portion 50 has to maintain a predetermined thickness t that allows the LED luminous flux converting lens 1 to be fixed while maintaining a predetermined mechanical intensity via the supporting plate 4. Thus, the smaller the thickness h of the LED luminous flux converting lens 1, a ratio t/h of the thickness t of the bonding portion 50 to the thickness h of the LED luminous flux converting lens 1 may increase.

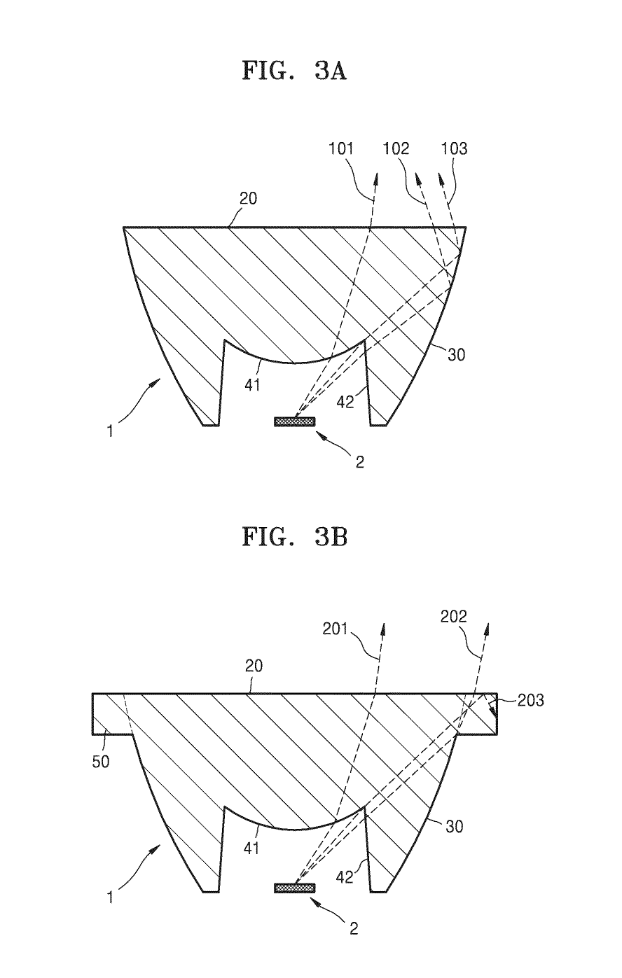

As illustrated in FIGS. 3A and 3B, the LED 2 is capable of emitting a luminous flux having directivity. A luminous flux emitted from the LED 2 may be incident into the LED luminous flux converting lens 1 via the refraction surface 41 or the inner side surface 42 of the LED luminous flux converting lens 1. The luminous flux that is incident into the LED luminous flux converting lens 1 may pass through the upper surface 20 directly or may pass through the upper surface 20 via total internal reflection on the outer side surface 30 to be emitted out of the LED luminous flux converting lens 1.

Meanwhile, when a module including the LED luminous flux converting lens 1 and the LED 2 is used as a camera flash, light emitted from the LED 2 may be irradiated according to an angle of view of a camera. That is, the LED luminous flux converting lens 1 may allow a luminous flux emitted from the LED 2 to be uniformly distributed over the angle of view of the camera and reduce an amount of the luminous flux deviating from the angle of view, thereby increasing efficiency. Like an angle of view of a camera, an area to which a luminous flux emitted from the LED 2 is to be irradiated is referred to as an illumination surface. Also, a ratio of a luminous flux that arrives at the illumination surface with respect to an output luminous flux of the LED 2 is referred to as a luminous flux efficiency.

FIG. 3A illustrates a function of an LED luminous flux converting lens 1 that does not include a bonding portion. As illustrated in FIG. 3A, a portion 101 of a luminous flux emitted from the LED 2 may be incident into the LED luminous flux converting lens 1 through the refraction surface 41, and pass through an inner portion of the LED luminous flux converting lens 1 and the upper surface 20 to be emitted out of the LED luminous flux converting lens 1.

Meanwhile, a portion 102 or 103 of the luminous flux emitted from the LED 2 may be incident into the LED luminous flux converting lens 1 through the inner side surface 42, and may pass through the inner portion of the LED luminous flux converting lens 1 to be incident to the outer side surface 30. The portion 102 or 103 of the luminous flux incident to the outer side surface 30 may be refracted on the outer side surface 30 via total internal reflection, and the refracted portion 102 or 103 of the luminous flux may pass through the upper surface 20 to be emitted out of the LED luminous flux converting lens 1. Accordingly, the LED luminous flux converting lens 1 may focus the luminous flux emitted from the LED 2 to an illumination surface.

FIG. 3B is a schematic view illustrating a function of an LED luminous flux converting lens 1 including a bonding portion 50. As illustrated in FIG. 3B, a portion 201 of a luminous flux emitted from the LED 2 may be incident to the LED luminous flux converting lens 1 through the refraction surface 41, and pass through the inner portion of the LED luminous flux converting lens 1 and the upper surface 20 to be emitted out of the LED luminous flux converting lens 1.

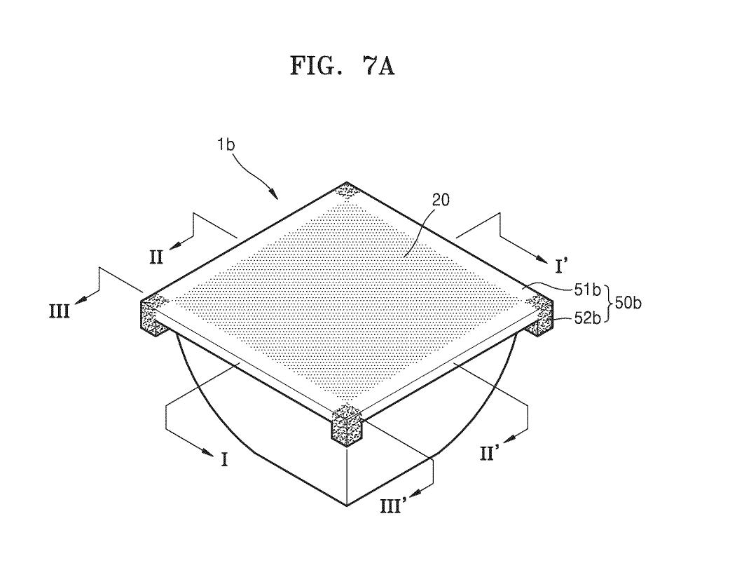

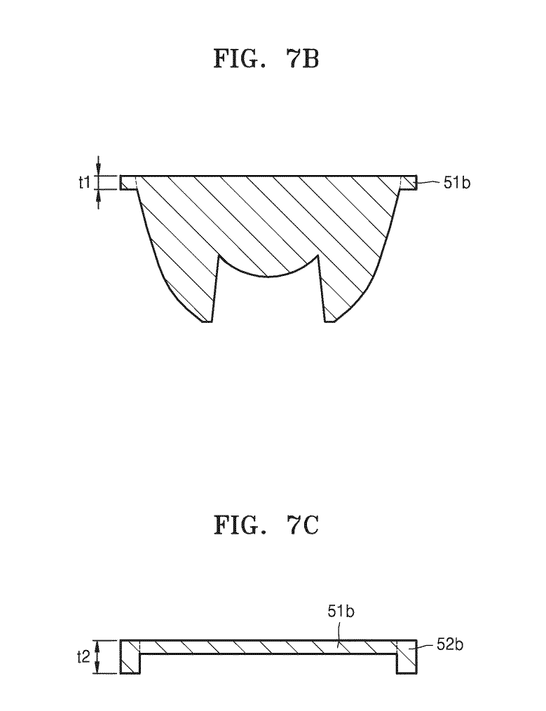

Meanwhile, a portion 202 or 203 of the luminous flux emitted from the LED 2 may be incident to the LED luminous flux converting lens 1 through the inner side surface 42, and may pass through the inner portion of the LED luminous flux converting lens 1 to be incident to an upper surface of the bonding portion 50. The portion 202 of the luminous flux that is incident on the upper surface of the bonding portion 50 may be emitted out of the LED luminous flux converting lens 1, and another portion 203 of the luminous flux incident on the upper surface of the bonding portion 50 may be reflected so as to proceed into the LED luminous flux converting lens 1 again via total internal reflection. An incident angle of the portion 202 of the luminous flux that is incident on the upper surface of the bonding portion 50 and is emitted to the outside is large, and thus, the portion 202 of the luminous flux may be refracted out of the illumination surface. A light intensity of the portion 203 of the luminous flux that is reflected again into the LED luminous flux converting lens 1 via total internal reflection on the upper surface of the bonding portion 50 may decrease as a light path of the portion 203 of the luminous flux becomes longer. Accordingly, an LED luminous flux converting lens 1b (see FIG. 7A) including the bonding portion 50 may have a low luminous flux efficiency due to the luminous flux that is lost due to the bonding portion 50, such as the portions 202 or 203.

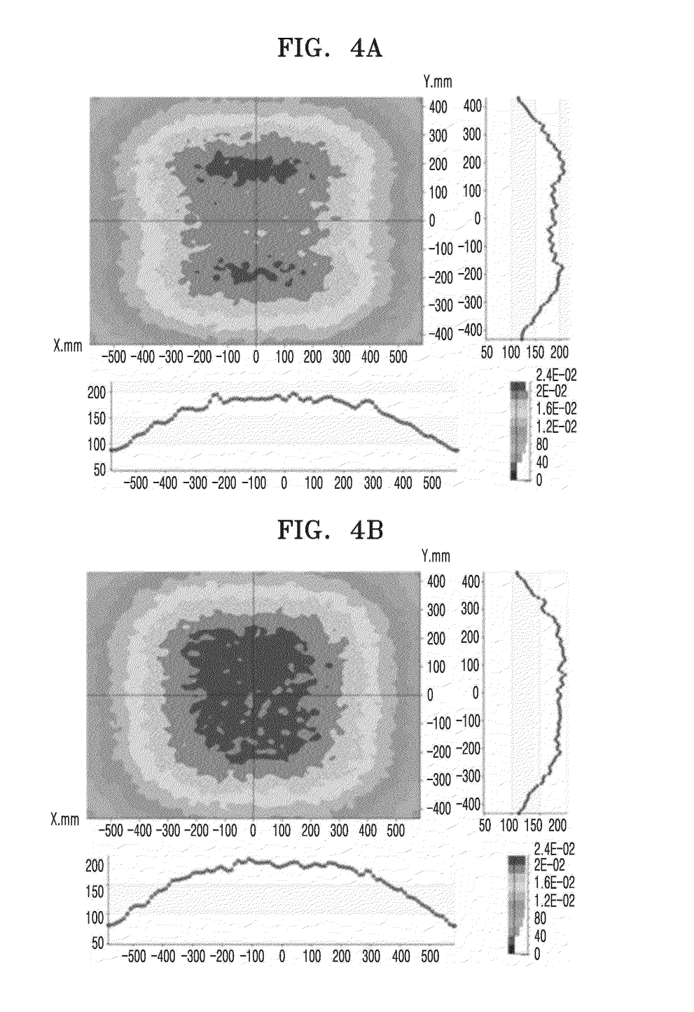

FIG. 4A is a graph showing illuminance distribution of light that passes through an LED luminous flux converting lens that does not include a bonding portion as illustrated in FIG. 3A, and FIG. 4B is a graph showing illuminance distribution of light that passes through an LED luminous flux converting lens including a bonding portion as illustrated in FIG. 3B. The LED luminous flux converting lens used in an experiment has a thickness of 2.09 mm, and the bonding portion of the LED luminous flux converting lens of FIG. 3B has a thickness of 0.3 mm. As a result of the experiment, the luminous flux efficiency of the LED luminous flux converting lens not including a bonding portion was 57.9%, and the LED luminous flux converting lens including the bonding portion had a luminous flux efficiency of 54.7%. That is, FIGS. 3A, 3B, 4A, and 4B indicate that the bonding portion for fixing the LED luminous flux converting lens has a negative influence on a luminous flux efficiency of the LED luminous flux converting lens.

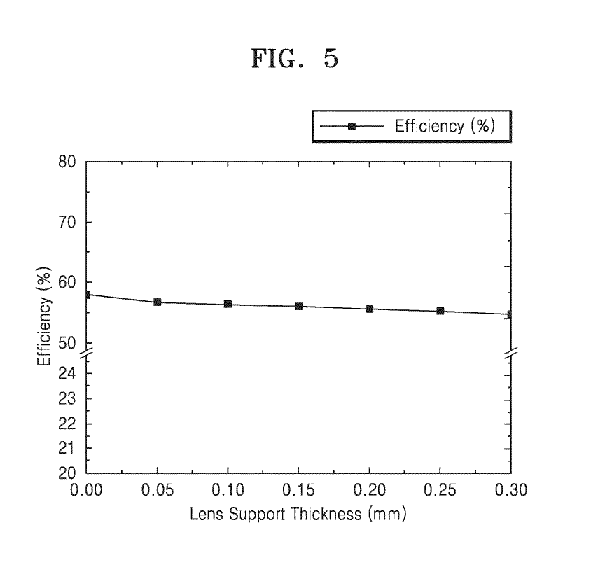

FIG. 5 is a graph showing a variation in luminous flux efficiency according to a thickness of a bonding portion. As illustrated in FIG. 5, when a thickness of an LED luminous flux converting lens is fixed, a luminous flux efficiency of the LED luminous flux converting lens continuously reduces from 57.9% to 54.7% as the thickness of the bonding portion increases from 0 mm to 0.3 mm. Accordingly, FIG. 5 reveals that the smaller the thickness of the bonding portion for fixing the LED luminous flux converting lens to a supporting plate, the larger the luminous flux efficiency of the LED luminous flux converting lens may be.

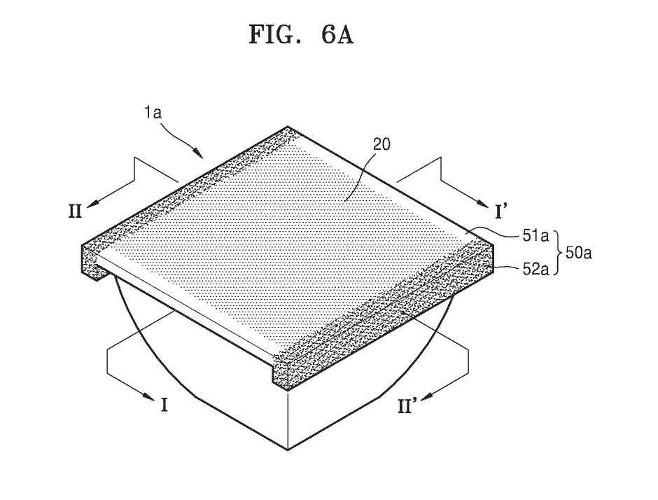

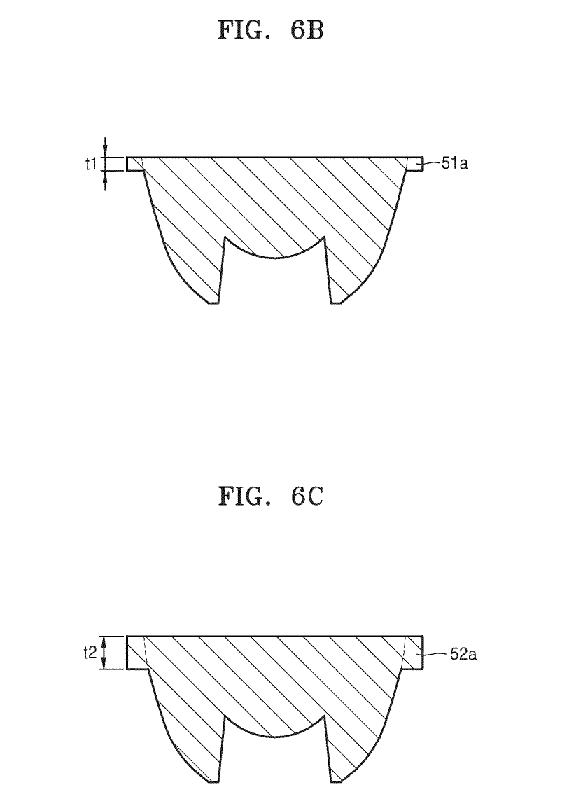

According to embodiments of the present disclosure, the LED luminous flux converting lens may include a bonding portion that is bonded to a supporting plate for fixing the LED luminous flux converting lens, and the bonding portion may include first and second portions that have different thicknesses. The LED luminous flux converting lens according to current embodiments of the present disclosure will be described with reference to FIGS. 6A through 6C and FIGS. 7A through 7C.

FIG. 6A is a perspective view of the LED luminous flux converting lens 1a according to an embodiment of the present disclosure, FIG. 6B is a cross-sectional view of the LED luminous flux converting lens 1a cut along a line I-I′, and FIG. 6C is a cross-sectional view illustrating the LED luminous flux converting lens 1a cut along a line II-II′.

As illustrated in FIG. 6A, the LED luminous flux converting lens 1a may include a bonding portion 50a protruded from the upper surface 20 in a horizontal direction. The bonding portion 50a may include a first portion 51a having a thickness t1 and a second portion 52a having a thickness t2. The thickness t2 of the second portion 52a may be thicker than the thickness t1 of the first portion 51a, and the second portion 52a may have a sufficient thickness such that it may not easily separate from the LED luminous flux converting lens 1a in the event of an external impact.

Also, the thickness t1 of the first portion 51a is thinner than the thickness t2 of the second portion 52a. Thus, an amount of a luminous flux lost due to the first portion 51a from among a luminous flux emitted from the LED may be smaller than an amount of a luminous flux that is lost due to the second portion 52a. Accordingly, the LED luminous flux converting lens 1a illustrated in FIGS. 6A through 6C may have a higher luminous flux efficiency than an LED luminous flux converting lens that includes a bonding portion protruded from the entire boundary of an upper surface thereof, due to a thickness necessary for a mechanical intensity (e.g., the thickness t2).

FIG. 7A is a perspective view of the LED luminous flux converting lens 1b according to the current embodiment of the present disclosure, FIG. 7B is a cross-sectional view of the LED luminous flux converting lens 1b cut along a line I-I′, and FIG. 7C is a cross-sectional view illustrating the LED luminous flux converting lens 1b cut along a line III-III′. The cross-sectional view of the LED luminous flux converting lens 1b cut along a line II-II′ of FIG. 7A may be the same as the cross-sectional view of the LED luminous flux converting lens 1b cut along the line I-I′ of FIG. 7A, both of which are illustrated by FIG. 7B.

As illustrated in FIG. 7A, the LED luminous flux converting lens 1b may include a bonding portion 50b protruded from the upper surface 20 in a horizontal direction. Like the embodiment illustrated in FIGS. 6A through 6C, the bonding portion 50b may include a plurality of first portions 51b having a thickness t1 and a second portion 52b having a thickness t2. The thickness t2 of the second portion 52b may be thicker than the thickness t1 of the first portions 51b, and the second portion 52b may have a sufficient thickness such that it may not easily separate from the LED luminous flux converting lens 1a in the event of an external impact.

As illustrated in FIGS. 7A through 7C, the first portion 51b may protrude from a portion of respective sides of the upper surface 20, and the second portion 52b may be connected to each vertex of the upper surface 20 and may be formed or disposed between the adjacent first portions 51b. That is, only the thickness t2 of the second portion 52b near each vertex of the upper surface 20 from among the bonding portion 50b may be set to be relatively thick, and the other portion, that is the first portion 51b, may be set to be relatively thin, thereby reducing loss in a luminous flux due to the first portion 51b of the bonding portion 50b and increasing a luminous flux efficiency of the LED luminous flux converting lens 1b.

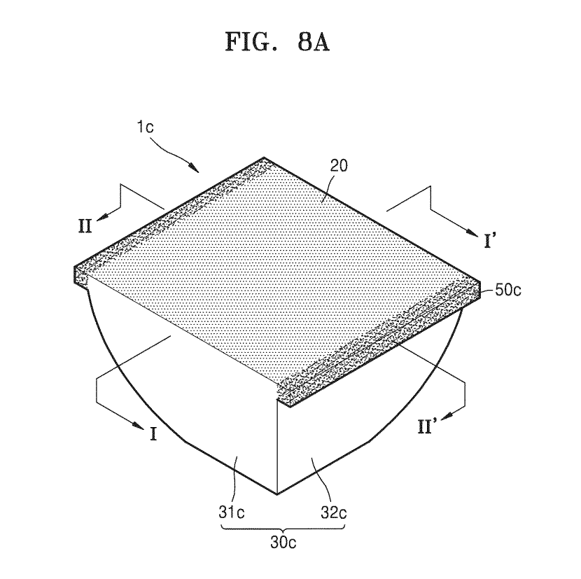

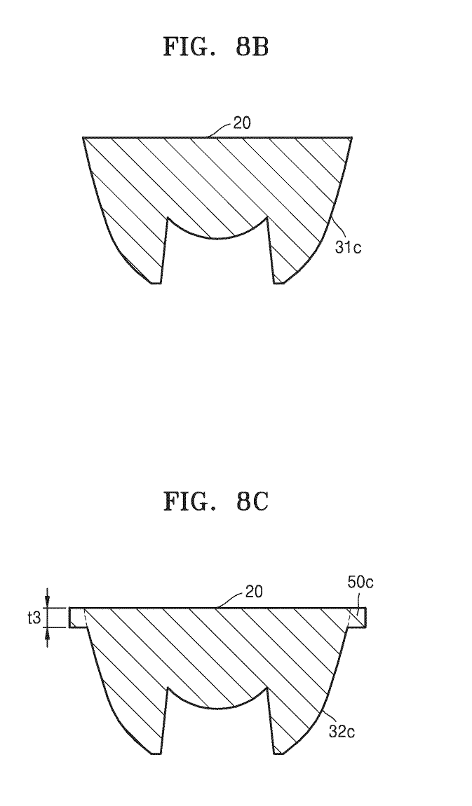

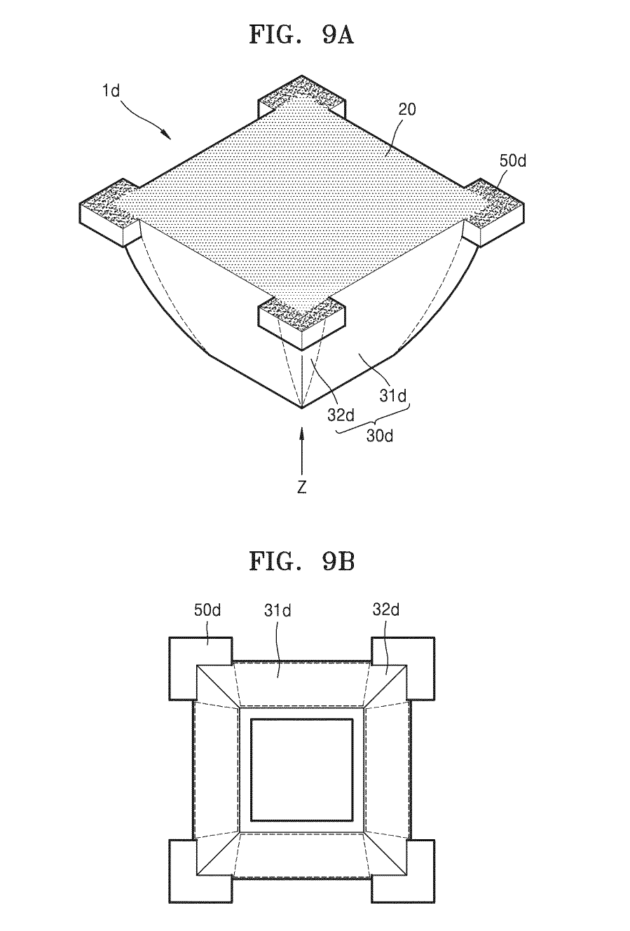

According to embodiments of the present disclosure, the LED luminous flux converting lens 1c may include a bonding portion and an outer side surface, and the bonding portion may protrude from a portion of a boundary of an upper surface. The outer side surface extending from the lower surface to the upper surface may include a first area connected to the upper surface and a second area connected to the bonding portion. The LED luminous flux converting lens 1c according to an embodiment of the present disclosure will be described with reference to FIGS. 8A through 8C and FIGS. 9A and 9B.

FIG. 8A is a perspective view of the LED luminous flux converting lens 1c, FIG. 8B is a cross-sectional view of the LED luminous flux converting lens 1c cut along a line I-I′, and FIG. 8C is a cross-sectional view illustrating the LED luminous flux converting lens 1c cut along a line II-II′.

As illustrated in FIG. 8A, the LED luminous flux converting lens 1c may include a bonding portion 50c that is protruded from a portion of a boundary of an upper surface 20 in a horizontal direction. An outer side surface 30c of the LED luminous flux converting lens 1c may include a first area 31c that connects a lower surface and an upper surface 20, and a second area 32c that connects the lower surface and the bonding portion 50c. A thickness t3 of the bonding portion 50c may have a sufficient thickness such that the bonding portion 50c does not easily separate from the LED luminous flux converting lens 1c in the event of an external impact.

The bonding portion 50c may protrude from a pair of parallel sides of the upper surface 20, and each side from which the bonding portion 50c does not protrude may be connected to the lower surface via the first area 31c. The bonding portion 50c is not formed or disposed where the first area 31c and the upper surface 20 are connected. Thus, light loss due to the bonding portion 50c may not occur.

FIG. 9A is a schematic perspective view of the LED luminous flux converting lens 1d, and FIG. 9B illustrates the LED luminous flux converting lens 1d of FIG. 9A viewed in a Z direction.

As illustrated in FIG. 9A, the LED luminous flux converting lens 1d may include a bonding portion 50d that protrudes from a portion of a boundary of an upper surface 20 in a horizontal direction. Like the embodiment illustrated in FIGS. 8A through 8C, an outer side surface 30d of the LED luminous flux converting lens 1d may include a first area 31d that connects a lower surface and the upper surface 20, and a second area 32d that connects the lower surface and the bonding portion 50d.

As illustrated in FIGS. 9A and 9B, a portion of each side of the upper surface 20 and the lower surface may be connected via the first area 31d, and the bonding portion 50d is connected to each vertex of the upper surface 20, and may protrude from a portion of the boundary of the upper surface 20 that is not connected to the first area 31d. Accordingly, the bonding portion 50d is formed only in a portion of the boundary of the upper surface 20 near each vertex, and the rest of the portion of the boundary of the upper surface 20 is directly connected to the lower surface via the first area 31d, thereby reducing loss in a luminous flux due to the bonding portion 50d and increasing a luminous flux efficiency. In particular, when the LED luminous flux converting lens 1d is used in a camera flash, an illumination surface where a luminous flux is irradiated may have a rectangular shape. As illustrated in FIGS. 9A and 9B, the bonding portion 50d is formed only in portions near each vertex of the upper surface 20, and thus an influence of loss in a luminous flux due to the bonding portion 50d on the illumination surface may be reduced.

According to embodiments of the present disclosure, horizontal cross-sections of the upper surface, the lower surface, the outer side surface, and the recess of the LED luminous flux converting lens may be rectangular. The rectangular shape may have an appropriate aspect ratio for an angle of view of a camera lens.

Also, while the horizontal cross-sections of the upper surface, the lower surface, the outer side surface, and the recess of the LED luminous flux converting lens having a rectangular shape are illustrated in the above embodiments of the present disclosure, the embodiments of the present disclosure are not limited thereto. For example, the LED luminous flux converting lens may have horizontal cross-sections that are circular, oval or the like.

While the present disclosure has been particularly shown and described with reference to exemplary embodiments thereof, it will be understood that various changes in form and details may be made therein without departing from the spirit and scope of the following claims.

What is claimed is:

1. A light emitting device (LED) luminous flux converting lens comprising:
a lower surface that is separated from a substrate on which an LED is mounted, the lower surface facing the LED;
an upper surface that is larger than the lower surface and is parallel to the lower surface;
an outer side surface that extends from the lower surface to the upper surface; and
a bonding portion that protrudes from a boundary of the upper surface and is bonded to a supporting plate that fixes the LED luminous flux converting lens,
wherein the bonding portion comprises a plurality of first portions and a second portion that is thicker than the first portions in a vertical direction.

2. The LED luminous flux converting lens of claim 1, wherein a horizontal cross-section of the upper surface, a horizontal cross-section of the lower surface, and a horizontal cross-section of the outer side surface are rectangular.

3. The LED luminous flux converting lens of claim 2, wherein the first portion protrudes from a pair of parallel sides of the upper surface, and the second portion protrudes from another pair of parallel sides of the upper surface.

4. The LED luminous flux converting lens of claim 2, wherein the plurality of first portions protrude from a portion of respective sides of the upper surface, and
the second portion is connected to each vertex of the upper surface and is disposed between the adjacent first portions.

5. The LED luminous flux converting lens of claim 2, wherein the rectangular horizontal cross-section of the upper surface, the rectangular horizontal cross-section of the lower surface, and the rectangular horizontal cross-section of the outer side surface each have an aspect ratio that is appropriate for an angle of view of a camera lens.

6. The LED luminous flux converting lens of claim 1, further comprising:
a recess that is dented in the lower surface;
a refraction surface that has an aspherical lens structure and is disposed on a bottom surface of the recess; and
an inner side surface that extends from the refraction surface to the lower surface.

7. The LED luminous flux converting lens of claim 1, wherein a vertical thickness of the second portion is one of greater than or equal to 0.2 mm and equal to or less than a thickness of the LED luminous flux converting lens, and
a vertical thickness of the first portion is equal to or less than half of the vertical thickness of the second portion.

8. A light emitting device (LED) luminous flux converting lens comprising:
a lower surface that is separated from a substrate on which an LED is mounted, the lower surface facing the LED;
an upper surface that is larger than the lower surface and is parallel to the lower surface;
an outer side surface that extends from the lower surface to the upper surface; and
a bonding portion that protrudes from a portion of a boundary of the upper surface and is bonded to a supporting plate that fixes the LED luminous flux converting lens,
wherein the outer side surface comprises a first area that connects the lower surface and the upper surface and a second area that connects the lower surface and the bonding portion.

9. The LED luminous flux converting lens of claim 8, wherein a horizontal cross-section of the upper surface, a horizontal cross-section of the lower surface, and a horizontal cross-section of the outer side surface are rectangular.

10. The LED luminous flux converting lens of claim 9, wherein the bonding portion protrudes from a pair of parallel sides of the upper surface, and the first area connects another pair of parallel sides of the upper surface and the lower surface.

11. The LED luminous flux converting lens of claim 9, wherein the first area connects a portion of each side of the upper surface and the lower surface, and
the bonding portion is connected to each vertex of the upper surface and protrudes from a portion of the boundary of the upper surface that is not connected to the first area.

12. The LED luminous flux converting lens of claim 9, wherein the rectangular horizontal cross-section of the upper surface, the rectangular horizontal cross-section of the lower surface, and the rectangular horizontal cross-section of the outer side surface each have an aspect ratio that is appropriate for an angle of view of a camera lens.

13. The LED luminous flux converting lens of claim 8, further comprising:
a recess that is dented in the lower surface;
a refraction surface that has an asphercial lens structure and is disposed on a bottom surface of the recess; and
an inner side surface that extends from the refraction surface to the lower surface.

14. The LED luminous flux converting lens of claim 8, wherein a vertical thickness of the bonding portion is one of greater than or equal to 0.2 mm and equal to or less than a thickness of the LED luminous flux converting lens.

15. The LED luminous flux converting lens of claim 8, wherein the LED luminous flux converting lens comprises silicon.

16. A lighting apparatus comprising:
a substrate;
a light emitting device (LED) disposed on an upper surface of the substrate; and
an LED luminous flux converting lens disposed over the LED, wherein the LED luminous flux converting lens comprises:
a lower surface that is separated from the substrate on which the LED is disposed, the lower surface facing the LED;
an upper surface that is larger than the lower surface;
an outer side surface that extends from the lower surface to the upper surface; and
a bonding portion that protrudes from a boundary of the upper surface and is bonded to a supporting plate that fixes the LED luminous flux converting lens,
wherein the bonding portion comprises a plurality of first portions and a second portion that is thicker than the first portions in a vertical direction.

17. The lighting apparatus of claim 16, further comprising:
a supporting plate disposed on the substrate, wherein the LED luminous flux converting lens is disposed on the supporting plate and a portion of the LED luminous flux converting lens is bonded to the supporting plate.

18. The lighting apparatus of claim 16, wherein the bonding portion protrudes from a pair of parallel sides of the upper surface, and the first area connects another pair of parallel sides of the upper surface and the lower surface.

19. The lighting apparatus of claim 16, wherein the first area connects a portion of each side of the upper surface and the lower surface, and the bonding portion is connected to each vertex of the upper surface and protrudes from a portion of the boundary of the upper surface that is not connected to the first area.

20. The lighting apparatus of claim 16, further comprising:
a recess that is dented in the lower surface;
a refraction surface that has an asphercial lens structure and is disposed on a bottom surface of the recess; and
an inner side surface that extends from the refraction surface to the lower surface.
